(19) United States
(12) Patent Application Publication
(10) Pub. No.: US 2026/0238511 A1
(43) Pub. Date: Aug. 13, 2026

(54) METHOD AND APPARATUS FOR CONTROLLING COMMUNICATION OF DATA COLLISION AVOIDANCE IN DOMAIN AND A VEHICLE AND STORAGE MEDIUM INCLUDING THE SAME

(71) Applicants: HYUNDAI MOTOR COMPANY, Seoul (KR); KIA CORPORATION, Seoul (KR)

(72) Inventor: Kang Woon Seo, Hwaseong-si (KR)

(73) Assignees: HYUNDAI MOTOR COMPANY, Seoul (KR); KIA CORPORATION, Seoul (KR)

(21) Appl. No.: 19/295,072

(22) Filed: Aug. 8, 2025

(30) Foreign Application Priority Data
Feb. 7, 2025 (KR) 10-2025-0015686

(51) Int. Cl. H04L 12/413; H04L 12/40

(52) U.S. Cl. CPC H04L 12/413; H04L 2012/40273

(57) ABSTRACT

A method for controlling communication of data collision avoidance in a domain includes sequentially providing, by a first master communication node or the second master communication node respectively linked to a first domain and a second domain, transmission opportunities to a plurality of communication nodes linked to the first domain or the second domain during each period. The method further includes transmitting data received from at least one of the plurality of communication nodes between the first domain and the second domain within the first domain or the second domain in a transmission opportunity. The method further includes monitoring an amount of a data transmission of at least one of the plurality of communication nodes and selectively providing an additional transmission opportunity to at least one of the first master communication node or the second master communication node according to a result of monitoring the amount of the data transmission.

### CROSS-REFERENCE TO RELATED APPLICATION(S)

This application claims the benefit of and priority to Korean Patent Application No. 10-2025-0015686 filed on Feb. 7, 2025, the entire contents of which are incorporated herein by reference.

### TECHNICAL FIELD

The present disclosure relates to a method and apparatus for controlling communication of data collision avoidance in a domain, and the present disclosure relates to a vehicle and a storage medium including the same.

### BACKGROUND

As the electronicization of vehicle components has rapidly progressed, the types and number of electronic devices (e.g., electronic control unit (ECU)) mounted on vehicles have significantly increased. Electronic devices may be broadly used in power train control systems, body control systems, chassis control systems, vehicle networks, multimedia systems, and the like. Here, power train control systems may refer to an engine control system, an automatic transmission control system, and the like. Body control systems may refer to a body electrical component control system, a convenience device control system, a lamp control system, and the like. Chassis control systems may refer to a steering device control system, a brake control system, a suspension control system, and the like.

Meanwhile, vehicle networks may refer to a controller area network (CAN), a FlexRay-based network, a media oriented system transport (MOST)-based network, etc. Multimedia systems may refer to a navigation system, a telematics system, an infotainment system, and the like.

These systems and electronic devices constituting each of the systems may be connected through a vehicle network, and a vehicle network supporting the functions of each electronic device is currently required. CAN may support a transfer rate of up to 1 Mbps and may support automatic retransmission of collided frames and error detection based on cyclic redundancy check (CRC). The FlexRay-based network may support a transfer rate of up to 10 Mbps and may support simultaneous transmission of data through two channels and synchronous data transmission. The MOST-based network is a communication network for high-quality multimedia and may support a transfer rate of up to 150 Mbps.

Meanwhile, telematics systems, infotainment systems, and enhanced safety systems in vehicles require high transfer rates and system expandability, and CAN and FlexRay-based networks do not sufficiently support high transfer rates and system expandability. MOST-based networks may support high transfer rates compared to CAN and FlexRay-based networks, but high costs may incur to apply MOST-based networks to all networks in vehicles. Due to these problems, Ethernet-based networks may be considered to be vehicle networks. Ethernet-based networks may support bidirectional communication through a pair of coils and may support a transfer rate of up to 10 Gbps.

One of the Ethernet protocols that a vehicle network may support may be 10 single pair Ethernet (SPE). In the case of 10 SPE in which a plurality of nodes is connected, if the plurality of end nodes wants to simultaneously transmit data packets to other end nodes, collisions may occur between different data packets in a physical (PHY) layer. The plurality of end nodes linked to the 10 SPE network may use a PHY layer collision avoidance (PLCA) function to avoid collisions in the PHY layer. The PLCA function refers to a function of sequentially providing transmission opportunities to a plurality of end nodes linked to the 10SPE network to transmit data packets. The PLCA function may provide improved performance in a multidrop Ethernet network with a small number of nodes (less than 16) and low propagation delay.

Communication nodes constituting the Ethernet vehicle-based network may be connected in a bus-type network topology. An interface specified in Institute of Electrical and Electronics Engineers (IEEE) 802.3cg may support the carrier sense multi-access/collision detection (CSMA/CD) function considering collisions between messages and the PLCA function not considering collisions. In general, in the bus network topology, when a communication network operates with the PLCA function, the network efficiency may be higher than when it operates with the CSMA/CD function. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

A method for preventing data collisions in a domain, such as PLCA, may cause more communication delay time when the amount of data transmitted by a communication node increases.

An aspect of the present disclosure aims to provide a method and an apparatus for controlling communication of data collision avoidance in a domain and provide a vehicle and a storage medium including the same, capable of reducing communication delay time, while preventing a data collision in a domain.

According to an aspect of the present disclosure, a method for controlling communication of data collision avoidance in a domain includes sequentially providing, by a first master communication node or a second master communication node respectively linked to a first domain and a second domain, transmission opportunities to a plurality of communication nodes linked to the first domain or the second domain during each period. The method further includes transmitting, by the first master communication node or the second master communication node, data received from at least one of the plurality of communication nodes between the first domain and the second domain within the first domain or the second domain in a transmission opportunity. The method further includes monitoring an amount of a data transmission of at least one of the plurality of communication nodes. The method further includes selectively providing an additional transmission opportunity to at least one of the first master communication node or the second master communication node according to a result of monitoring the amount of the data transmission.

Transmitting, by the first master communication node or the second master communication node, the data between the first domain and the second domain is not limited to the transmission opportunities of the first master communication node and the second master communication node.

The plurality of communication nodes may be restricted from transmitting data out of the linked first domain or the linked second domain by bypassing the first master communication node and the second master communication node.

The method may further include receiving a message including the data according to Ethernet from at least one of the plurality of communication nodes. The method may further include transmitting the message including the data according to Ethernet between the first domain and the second domain. The method may further include transmitting the message including the data according to Ethernet within the first domain or the second domain in the transmission opportunity.

The method may further include transmitting, by the first master communication node or the second master communication node, a beacon signal to the plurality of communication nodes during each period.

The method may further include selectively transmitting a turn setting message for delaying a transmission opportunity turn of at least some of the plurality of communication nodes to at least some of the plurality of communication nodes. The method may further include, according to the result of monitoring the amount of the data transmission, selectively providing an additional transmission opportunity of a front turn of the delayed transmission opportunity turn of one period to at least one of the first master communication node or the second master communication node.

The method may further include selectively providing an additional transmission opportunity of a last turn of one period to at least one of the first master communication node or the second master communication node according to the result of monitoring the amount of the data transmission.

The method may further include monitoring, by at least one of the first master communication node or the second master communication node, the amount of the data transmission of at least one of the plurality of communication nodes by checking the amount of the data transmission of a data transmission request received from at least one of the plurality of communication nodes.

The method may further include monitoring, by at least one of the first master communication node or the second master communication node, a total amount of the data transmission of the plurality of communication nodes.

The method may further include monitoring, by at least one of the first master communication node or the second master communication node, the amount of the data transmission in a previous period of at least one of the plurality of communication nodes. The method may further include selectively providing an additional transmission opportunity in a subsequent period than in the previous period to at least one of the first master communication node or the second master communication node according to the result of the monitoring the amount of the data transmission.

According to another aspect of the present disclosure, a vehicle includes: a computer device including a non-transitory computer readable storage medium configured to record one or more programs. The computer device further includes a processor configured, by executing the one or more programs, to perform the method for controlling the communication of the data collision avoidance in the domain.

According to another aspect of the present disclosure, a non-transitory computer readable storage medium configured to record one or more programs including commands for executing the method for controlling the communication of the data collision avoidance in the domain are recorded.

According to another aspect of the present disclosure, an apparatus for controlling communication of data collision avoidance in a domain includes: a first master communication node configured to sequentially provide transmission opportunities to a plurality of first communication nodes linked to a first domain during each period. The apparatus further includes a second master communication node configured to sequentially provides transmission opportunities to a plurality of second communication nodes linked to a second domain during each period. The first master communication node is further configured to receive data from at least one of the plurality of first communication nodes and transmit the data to the second master communication node. The second master communication node is further configured to transmit the data to at least one of the plurality of second communication nodes in a transmission opportunity. At least one of the first master communication node or the second master communication node is further configured to monitor an amount of a data transmission of at least one of the plurality of first communication nodes. At least one of the first master communication node or the second master communication node is further configured to selectively provide an additional transmission opportunity to the other one of the first master communication node or the second master communication node according to a result of monitoring the amount of the data transmission.

The first master communication node may receive a message including data according to Ethernet from at least one of the plurality of first communication nodes and may transmit the message to the second master communication node. The second master communication node may transmit the message including the data according to Ethernet to at least one of the plurality of second communication nodes.

The first master communication node and the second master communication node may transmit the data between the first domain and the second domain without being limited to the transmission opportunities of the first master communication node and the second master communication node. The plurality of first communication nodes may be restricted from transmitting data to the plurality of second communication nodes by bypassing the first master communication node and the second master communication node. The plurality of second communication nodes may be restricted from transmitting data to the plurality of first communication nodes by bypassing the first master communication node and the second master communication node.

The first master communication node may transmit a beacon signal to the plurality of first communication nodes during each period. The second master communication node may transmit a beacon signal to the plurality of second communication nodes during each period. At least one of the first master communication node or the second master communication node may selectively transmit a turn setting message for delaying a transmission opportunity turn of at least some of the plurality of second communication nodes to at least some of the plurality of second communication nodes. At least one of the first master communication node or the second master communication node may, according to the result of monitoring the amount of the data transmission, provide an additional transmission opportunity of a front turn of the delayed transmission opportunity turn of one period to the other one of the first master communication node and the second master communication node.

The first master communication node may transmit a beacon signal to the plurality of first communication nodes during each period. The second master communication node may transmit a beacon signal to the plurality of second communication nodes during each period. At least one of the first master communication node or the second master communication node may selectively provide an additional opportunity of a last turn of the one period to the other one of the first master communication node and the second master communication node according to the result of monitoring the amount of the data transmission.

At least one of the first master communication node or the second master communication node may monitor the amount of the data transmission of at least one of the plurality of first communication nodes by checking the amount of a data transmission of a data transmission request received from at least one of the plurality of first communication nodes.

According to another aspect of the present disclosure, a vehicle includes the apparatus for controlling the communication of the data collision avoidance in the domain.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a diagram illustrating an apparatus for controlling communication of data collision avoidance in a domain, a vehicle, and a storage medium according to an embodiment of the present disclosure;

FIG. 2A is a diagram illustrating an apparatus and method for controlling communication of data collision avoidance in a domain according to an embodiment of the present disclosure when the amount of a data transmission of a communication node is small (there is no initial transmission opportunity order of a master communication node);

FIG. 2B is a diagram illustrating an apparatus and a method for controlling communication of data collision avoidance in a domain according to an embodiment of the present disclosure when the amount of data transmitted by a communication node is large (there is no change in the transmission opportunity order of a communication node);

FIG. 3A is a diagram illustrating an apparatus and method for controlling communication of data collision avoidance in a domain according to an embodiment of the present disclosure when the amount of a data transmission of a communication node is small (there is an initial transmission opportunity order of a master communication node);

FIG. 3B is a diagram illustrating an apparatus and a method for controlling communication of data collision avoidance in a domain according to an embodiment of the present disclosure when the amount of a data transmission of a communication node is large (there is a change in the transmission opportunity order of a communication node);

FIG. 4 is a time flowchart illustrating a reduction in communication delay time according to an additional transmission opportunity of a master communication node in an apparatus and a method for controlling communication of data collision avoidance in a domain according to an embodiment of the present disclosure;

FIG. 5 is a flowchart illustrating a method for controlling communication of data collision avoidance in a domain (there is no change in the transmission opportunity order of a communication node) according to an embodiment of the present disclosure; and

FIG. 6 is a flowchart illustrating a method for controlling communication of data collision avoidance in a domain (there is a change in the transmission opportunity order of a communication node) according to an embodiment of the present disclosure.

### DETAILED DESCRIPTION

While the present disclosure may be modified in various ways and take on various alternative forms, embodiments of the present disclosure are shown in the drawings and described in detail below. However, it should be understood that there is no intent to limit the present disclosure to the particular forms disclosed. Instead, the present disclosure covers all modifications, equivalents, and alternatives falling within the spirit and scope of the present disclosure.

It should be understood that, although the terms “first,” “second,” etc. may be used herein to describe various elements, these elements should not be limited by these terms. These terms are only used to distinguish one element from another. For example, a first element could be termed as a second element, and a second element could similarly be termed as a first element without departing from the scope of the present disclosure. As used herein, the term “and/or” includes any and all combinations of one or more of the associated listed items.

The terms used herein to describe embodiments of the present disclosure is not intended to limit the scope of the present disclosure. The articles “a,” and “an” may be used to indicate the singular form. However, the use of the singular form in the present document should not preclude the plural form. In other words, an element of the present disclosure in the singular form may be one or more, unless the context clearly indicates otherwise. It should be further understood that the terms “comprise,” “comprising,” “include,” and/or “including,” when used herein, specify the presence of stated features, numbers, steps, operations, elements, and/or components and do not preclude the presence or addition of one or more other features, numbers, steps, operations, elements, components, and/or groups thereof.

Unless defined in a different way, all the terms used herein including technical and scientific terms have the same meanings as understood by those having ordinary skill in the art to which the present disclosure pertains. Such terms as defined in generally used dictionaries should be construed to have the same meanings as those of the contexts of the related art. Unless clearly defined in the present disclosure, the present disclosure should not be construed to have ideally or excessively formal meanings. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

In the present disclosure, vehicles refer to a variety of vehicles that move transported objects, such as people, animals, or goods, from a starting point to a destination. These vehicles are not limited to vehicles that run on roads or tracks.

Hereinafter, embodiments of the present disclosure are described with reference to the accompanying drawings.

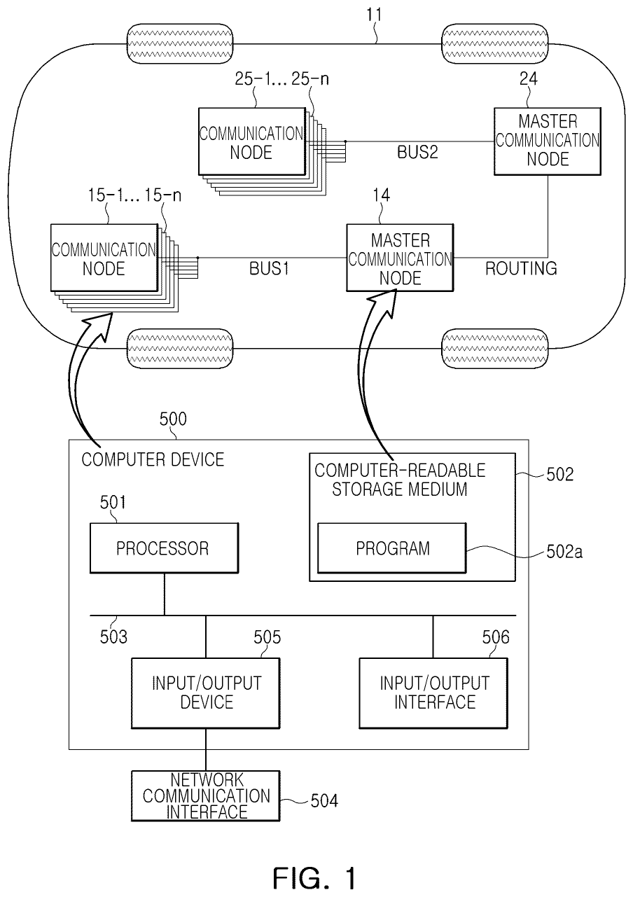

Referring to FIG. 1, a vehicle 11 according to an embodiment of the present disclosure may include a first master communication node 14 and/or a plurality of first communication nodes 15-1 to 15-n linked to a first domain BUS1. The vehicle 11 may further include a second master communication node 24 and/or a plurality of second communication nodes 25-1 to 25-n linked to a second domain BUS2. Depending on the design, the number of domains may be two or more.

For example, each of the first and second master communication nodes 14 and 24 and the plurality of first and second communication nodes 15-1 to 15-n and 25-1 to 25-n may be implemented as an electronic control module collecting, providing, and transmitting information necessary for driving, information required during driving, or information for enhancing driving safety from/to a user, driver, or passenger. Each of the first and second master communication nodes 14 and 24 and the plurality of first and second communication nodes 15-1 to 15-n and 25-1 to 25-n may include an information processing device capable of performing calculations based on collected information according to a preset program or function, as well as an information collecting device, such as a sensor or camera, to generate and process novel information.

For example, each of the first and second master communication nodes 14 and 24 and the plurality of first and second communication nodes 15-1 to 15-n and 25-1 to 25-n may be implemented as an electronic control unit (ECU) controlling various devices included in the vehicle. The ECU may be implemented as an ECU controlling an infotainment device (e.g., a display device, a navigation device, an around view monitoring device). The ECU may also be implemented as an engine control unit, a transmission control unit, an engine management system (EMS) ECU, a transmission management system (TMS) ECU, an airbag control module (ACU), an anti-locking brake system (ABS) ECU, a measuring instrument, and a driver information module.

Depending on the design, at least some of the plurality of first and second communication nodes 15-1 to 15-n and 25-1 to 25-n may be external to the vehicle 11 (e.g., telematics, on-board diagnostics (OBD)) or may include a relay communication node between the exterior and interior of the vehicle 11, such as a gateway.

The first master communication node 14 and each of the plurality of first communication nodes 15-1 to 15-n may transmit (e.g., transmit in a broadcast manner with no specified recipient) and may receive a message (e.g., a message including data according to Ethernet) through the first domain BUS1. The second master communication node 24 and each of the plurality of second communication nodes 25-1 to 25-n may transmit (e.g., transmit in a broadcast manner with no specified recipient) and may receive a message (e.g., a message including data according to Ethernet) through the second domain BUS2. For example, Ethernet may have a bandwidth of 10M bits per second (bps), but is not limited thereto.

A message transmitted by one of the plurality of first communication nodes 15-1 to 15-n linked to the first domain BUS1 may be easily received by the rest. A message transmitted by one of the plurality of second communication nodes 25-1 to 25-n linked to the second domain BUS2 may be easily received by the rest. For example, the first domain BUS1 may be implemented as a first bus channel shared by the first master communication node 14 and the plurality of first communication nodes 15-1 to 15-n. The second domain BUS2 may be implemented as a second bus channel shared by the second master communication node 24 and the plurality of second communication nodes 25-1 to 25-n.

The first domain BUS1 and the second domain BUS2 may be isolated from each other, and the plurality of first communication nodes 15-1 to 15-n may transmit (and/or receive) data to or from the plurality of second communication nodes 25-1 to 25-n via the first and second master communication nodes 14 and 24. The plurality of second communication nodes 25-1 to 25-n may transmit (and/or receive) data to or from the plurality of first communication nodes 15-1 to 15-n via the first and second master communication nodes 14 and 24. The plurality of first communication nodes 15-1 to 15-n may be restricted from transmitting data to the plurality of second communication nodes 25-1 to 25-n by bypassing the first and second master communication nodes 14 and 24 (e.g., there is no direct connection channel). The plurality of second communication nodes 25-1 to 25-n may be restricted from transmitting data to the plurality of first communication nodes 15-1 to 15-n by bypassing the first and second master communication nodes 14 and 24 (e.g., there is no direct connection channel).

Compared to a case in which a plurality of first and second communication nodes 15-1 to 15-n and 25-1 to 25-n are linked to one domain, a structure in which the plurality of first and second communication nodes 15-1 to 15-n and 25-1 to 25-n are divided and respectively linked to the first and second domains BUS1 and BUS2 may be advantageous in further simplifying the overall channel connection structure between the plurality of first and second communication nodes 15-1 to 15-n and 25-1 to 25-n. For example, a channel between the plurality of first communication nodes 15-1 to 15-n and the second master communication node 24 may be omitted, and a channel between the plurality of second communication nodes 25-1 to 25-n and the first master communication node 14 may be omitted, and thus the overall channel connection structure may be further simplified.

Referring to FIGS. 1, 2A, 2B, and 5, the method for controlling communication of data collision avoidance in a domain according to an embodiment of the present disclosure may include an operation (S110) in which one of the first and second master communication nodes 14 and 24 respectively linked to the first and second domains BUS1 and BUS2 sequentially provides transmission opportunities PLCA1, PLCA2, PLCA3, and PLCA4 of the plurality of communication nodes 15-1 to 15-n and 25-1 to 25-n linked to one of the first and second domains BUS1 and BUS2 during each period PD1. The apparatus for controlling communication of data collision avoidance in a domain according to an embodiment of the present disclosure may include the first master communication node 14 sequentially providing transmission opportunities PLCA1, PLCA2, PLCA3, and PLCA4 of the plurality of first communication nodes 15-1 to 15-n linked to the first domain BUS1 during each period PD1. The apparatus may further include the second master communication node 24 sequentially providing the transmission opportunities PLCA1, PLCA2, PLCA3, and PLCA4 of the plurality of second communication nodes 25-1 to 25-n linked to the second domain BUS2 during each period PD1.

Accordingly, data transmissions of the plurality of first communication nodes 15-1 to 15-n may be prevented from colliding in the first domain BUS1, and data transmissions of the plurality of second communication nodes 25-1 to 25-n may be prevented from colliding in the second domain BUS2. For example, if a plurality of data transmissions collides with each other, at least one of the plurality of data transmissions may cause a reception error.

For example, the first and second communication nodes 15-1 and 25-1 having a first turn may transmit data to the first and second domains BUS1 and BUS2 only when the first and second communication nodes 15-1 and 25-1 are provided with the first transmission opportunity PLCA1. The first and second communication nodes 15-2 and 25-2 having a second turn may transmit data to the first and second domains BUS1 and BUS2 only when the first and second communication nodes 15-2 and 25-2 are provided with the second transmission opportunity PLCA2. The first and second communication nodes 15-3 and 25-3 having a third turn may transmit data to the first and second domains BUS1 and BUS2 only when the first and second communication nodes 15-3 and 25-3 are provided with the third transmission opportunity PLCA3. The first and second communication nodes 15-4 and 25-4 having a fourth turn may transmit data to the first and second domains BUS1 and BUS2 only when the first and second communication nodes 15-4 and 25-4are provided with the fourth transmission opportunity PLCA4.

As the number of the plurality of first communication nodes 15-1 to 15-n linked to the first domain BUS1 increases, one period PD1 of the first domain BUS1 may become longer. As the number of the plurality of second communication nodes 25-1 to 25-n linked to the second domain BUS2 increases, one period PD1 of the second domain BUS2 may become longer. Depending on the design, the number of the plurality of first communication nodes 15-1 to 15-n and the number of the plurality of second communication nodes 25-1 to 25-n may be different from each other.

Compared to a case in which a plurality of first and second communication nodes 15-1 to 15-n and 25-1 to 25-n are linked to one domain, one period PD1 of a structure in which the plurality of first and second communication nodes 15-1 to 15-n and 25-1 to 25-n are divided and respectively linked to the first and second domains BUS1 and BUS2 (a structure in which the overall channel connection structure is more simplified) may be relatively shorter and each of the plurality of first and second communication nodes 15-1 to 15-n and 25-1 to 25-n may be provided with more frequent (and/or longer) transmission opportunities PLCA1, PLCA2, PLCA3, and PLCA4. Accordingly, the overall communication required time of the plurality of first and second communication nodes 15-1 to 15-n and 25-1 to 25-n may be shortened, and the amount of a data transmission for unit time of the plurality of first and second communication nodes 15-1 to 15-n and 25-1 to 25-n may be increased.

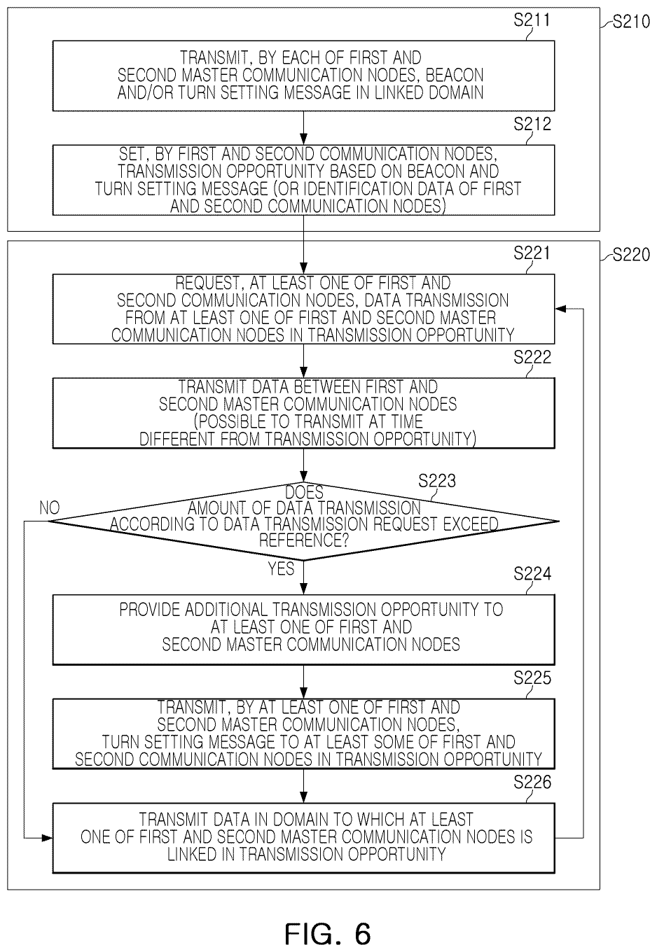

The method for controlling communication of data collision avoidance in a domain according to an embodiment of the present disclosure may include an operation (S120) in which one of the first and second master communication nodes 14 and 24 receives data (Data) (e.g., a message including data according to Ethernet) from at least one (e.g., the first communication node 15-2) of the plurality of communication nodes 15-1 to 15-n and 25-1 to 25-n, transmits (ROUTING) the data (Data) between the first and second domains BUS1 and BUS2 (S222 of FIG. 6), and transmits the data (Data) (e.g., the message including data according to Ethernet) within a domain to which at least one of the first and second master communication nodes 14 and 24 is linked in a transmission opportunity TO (S124) (S226 of FIG. 6). The first master communication node 14 may receive the data (Data) (e.g., the message including data according to Ethernet) from at least one of the plurality of first communication nodes 15-1 to 15-n and may transmit the data (Data) (e.g., the message including data according to Ethernet) to the second master communication node 24. The second master communication node 24 may transmit the data (Data) (e.g., the message including data according to Ethernet) to at least one of the plurality of second communication nodes 25-1 to 25-n at the transmission opportunity TO.

For example, the transmission (ROUTING) of data (Data) between the first and second domains BUS1 and BUS2 may include peer-to-peer routing and may include routing through a channel separated from the first and second domains BUS1 and BUS2. The transmitting operation (S120) may include transmitting (routing), by one of the first and second master communication nodes 14 and 24, data (Data) between the first and second domains BUS1 and BUS2 without being limited to the transmission opportunity TO of the first and second master communication nodes 14 and 24. The first and second master communication nodes 14 and 24 may transmit (route) data (Data) between the first and second domains BUS1 and BUS2 without being limited to the transmission opportunity TO of the first and second master communication nodes 14 and 24. For example, one of the first and second master communication nodes 14 and 24 may transmit (route) data (Data) between the first and second domains BUS1 and BUS2 immediately after receiving the data (Data) from at least one (e.g., the first communication node 15-2) of the plurality of communication nodes 15-1 to 15-n and 25-1 to 25-n (or at the earliest possible time point at which transmission may start).

For example, the first master communication node 14 may transmit beacon signals BC1 and BC2 to the plurality of first communication nodes 15-1 to 15-n through the first domain BUS1. The second master communication node 24 may transmit the beacon signals BC1 and BC2 to the plurality of second communication nodes 25-1 to 25-n through the second domain BUS2. A duration from the time when the beacon signals BC1 and BC2 are transmitted to the time when the first transmission opportunity PLCA1 starts may be a time during which the plurality of first and second communication nodes 15-1 to 15-n and 25-1 to 25-n are not provided with transmission opportunities PLCA1, PLCA2, PLCA3, and PLCA4. Thus, the duration may be utilized as the transmission opportunity TO of the first and second master communication nodes 14 and 24. Therefore, in the duration (e.g., default transmission opportunity) from the time when the beacon signals BC1 and BC2 are transmitted to the time when the first transmission opportunity PLCA1 starts, the first and second master communication nodes 14 and 24 may transmit the data (Data) transmitted between the first and second master communication nodes 14 and 24 to the plurality of first and second communication nodes 15-1 to 15-n and 25-1 to 25-n. Thus, data transmission collisions among the plurality of first and second communication nodes 15-1 to 15-n and 25-1 to 25-n may be prevented.

As a time difference between the time when one of the first and second master communication nodes 14 and 24 receives the data (Data) and the transmission opportunity TO of the first and second master communication nodes 14 and 24 increases, a total communication required time may become longer. As the first and second master communication nodes 14 and 24 are provided with more (or more frequently) transmission opportunities TO, the time difference (and the total communication required time) may be decreased, but one period PD1 may become longer, and the time each of the first and second communication nodes 15-1 to 15-n and 25-1 to 25-n waits to be provided with the transmission opportunities PLCA1, PLCA2, PLCA3, and PLCA4 may become longer.

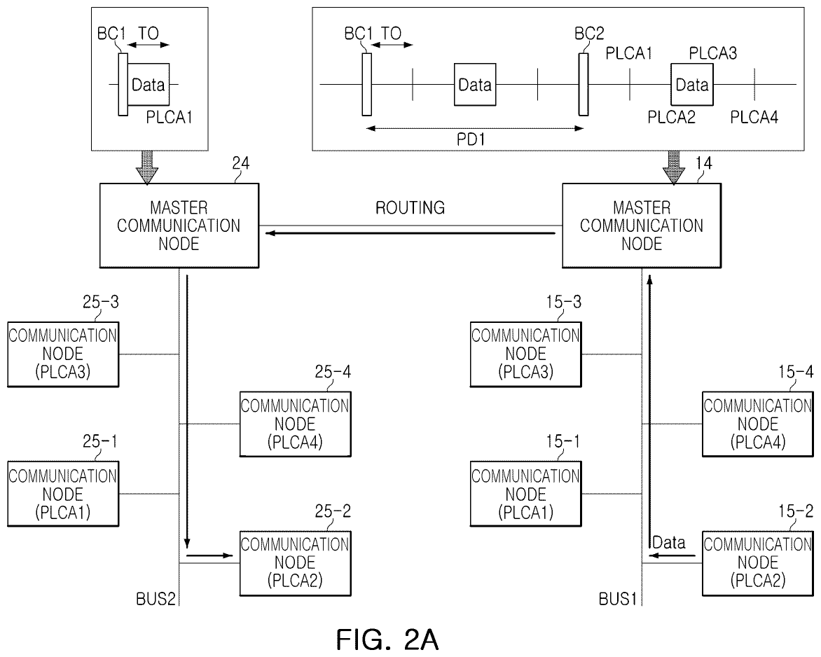

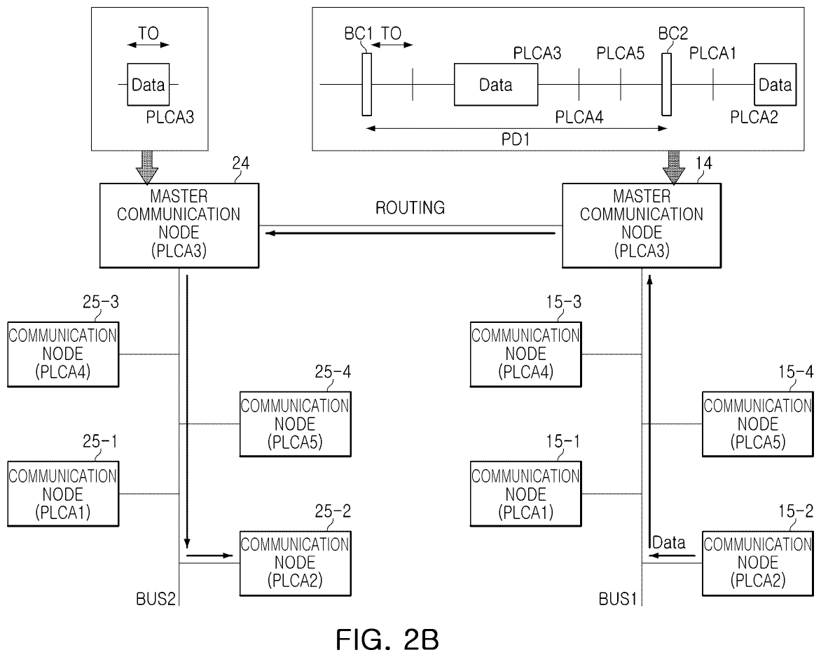

The transmitting operation (S120) may include monitoring the amount of a data transmission (e.g., the amount of packets of the data or length/number/bits of data, etc. of frames of the data) of at least one of the plurality of communication nodes 15-1 to 15-n and 25-1 to 25-n (S121). The transmitting operation (S120) may further include monitoring and determining whether the monitored amount of the data transmission exceeds a reference (S122). The transmitting operation (S120) may further include, when the amount of the data transmission exceeds the reference (Yes in S122), selectively providing an additional transmission opportunity (e.g., PLCA3 of FIG. 2B) to at least one of the first and second master communication nodes 14 and 24 according to the result of monitoring the amount of the data transmission(S123). At least one of the first and second master communication nodes 14 and 24 may monitor the amount of a data transmission of at least one of the plurality of first communication nodes 15-1 to 15-n and may selectively and/or dynamically provide an additional transmission opportunity (e.g., PLCA3 of FIG. 2B) to the second master communication node 24 according to the result of monitoring the amount of a data transmission. The transmitting operation (S120) may further include transmitting the data (Data) (e.g., the message including data according to Ethernet) within a domain to which at least one of the first and second master communication nodes 14 and 24 is linked in a transmission opportunity TO (S124).

As the amount of a data transmission of at least one (e.g., the first communication node 15-2) of the plurality of communication nodes 15-1 to 15-n and 25-1 to 25-n increases, the time difference (and the total communication required time) may become longer. Therefore, when the amount of the data transmission is greater than the reference, at least one of the first and second master communication nodes 14 and 24 may effectively reduce the time difference (and the total communication required time) and may reduce the communication delay time by providing an additional transmission opportunity (e.g., PLCA3 of FIG. 2B) to at least one of the first and second master communication nodes 14 and 24.

When the amount of the data transmission is less than the reference (No in S122), the efficiency of reducing the time difference (and the total communication required time) by providing an additional transmission opportunity (e.g., PLCA3 of FIG. 2B) may be relatively low. Accordingly, when the amount of a data transmission is less than the reference, at least one of the first and second master communication nodes 14 and 24 may not provide an additional transmission opportunity (e.g., PLCA3 of FIG. 2B) to at least one of the first and second master communication nodes 14 and 24 and uses only a default transmission opportunity. Thus, unnecessary extension of one period PD1 may be reduced, the time for each of the first and second communication nodes 15-1 to 15-n and 25-1 to 25-n to wait to receive the transmission opportunities PLCA1, PLCA2, PLCA3, and PLCA4 may be reduced, and the communication delay time may be reduced.

Referring to FIGS. 2A, 2B, and 6, the transmitting operation (S220) may include, by at least one of the first and second master communication nodes 14 and 24, selectively transmitting a turn setting message for delaying the transmission opportunity turn of at least some (e.g., 15-3, 15-4, 25-3, 25-4) of the plurality of communication nodes 15-1 to 15-n and 25-1 to 25-n (e.g., delaying from PLCA3-PLCA4 to PLCA4-PLCA5) to at least some (e.g., 15-3, 15-4, 25-3, 25-4) of the plurality of communication nodes according to result of monitoring the amount of a data transmission (S225). The transmitting operation (S220) may further include providing a front turn (e.g., PLCA3 in FIG. 2B) of the delayed turn of one period PD1 to at least one of the first and second master communication nodes 14 and 24 (S224).

Accordingly, a start time of the additional transmission opportunity (e.g., PLCA3 in FIG. 2B) provided to the first and second master communication nodes 14 and 24 may be set more flexibly, so that the communication delay time may be further reduced. The transmitting operation (S220) may further include transmitting, by at least one of the first and second master communication nodes 14 and 24 after the turn is reset, data (e.g., data transmitted (S222) between the first and second master communication nodes 14 and 24) within the first and second domains BUS1 and BUS2 in the transmission opportunity (S226).

For example, the providing operation (S210) may include providing the plurality of communication nodes 15-1 to 15-n and 25-1 to 25-n with identification data of each of the plurality of communication nodes 15-1 to 15-n and 25-1 to 25-n in advance (e.g., initial setting). The providing operation (S210) may further include transmitting, by the first and second master communication nodes 14 and 24 through the first and second domains BUS1 and BUS2 at the transmission opportunity TO, the beacon signals BC1 and BC2 (S211). The providing operation (S210) may further include determining that a time immediately after waiting for a time obtained by multiplying a time length of the transmission opportunity TO from the time point of receiving the beacon signals BC1 and BC2 by their own turn is their own transmission opportunity. The providing operation (S210) may further include setting transmission opportunities PLCA1, PLCA2, PLCA3, and PLCA4 accordingly (S212).

For example, the providing operation (S210) may include transmitting, by at least one of the first and second master communication nodes 14 and 24, a turn setting message to the plurality of communication nodes 15-1 to 15-n and 25-1 to 25-n (S211), while transmitting the beacon signals BC1 and BC2. The providing operation (S210) may further include changing, by at least some (e.g., 15-3, 15-4, 25-3, 25-4) of the plurality of communication nodes 15-1 to 15-n and 25-1 to 25-n, their own turn according to a turn change data included in the turn setting message. The providing operation (S210) may further include determining that a time immediately after waiting for a time obtained by multiplying a time length of the transmission opportunity TO from the time point of receiving the beacon signals BC1 and BC2 by their own turn is their changed transmission opportunity. The providing operation (S210) may further include setting the transmission opportunities PLCA1, PLCA2, PLCA4, and PLCA5 accordingly (S212).

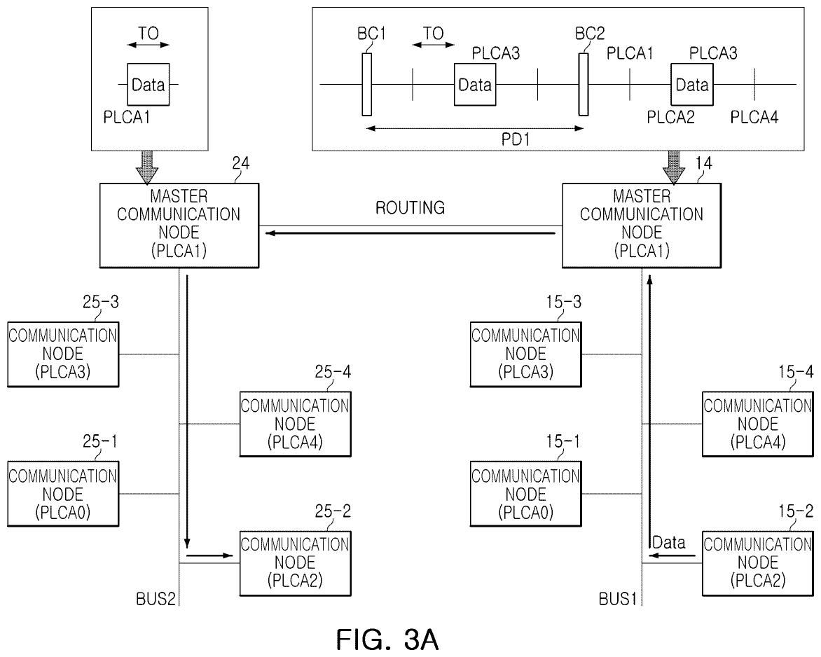

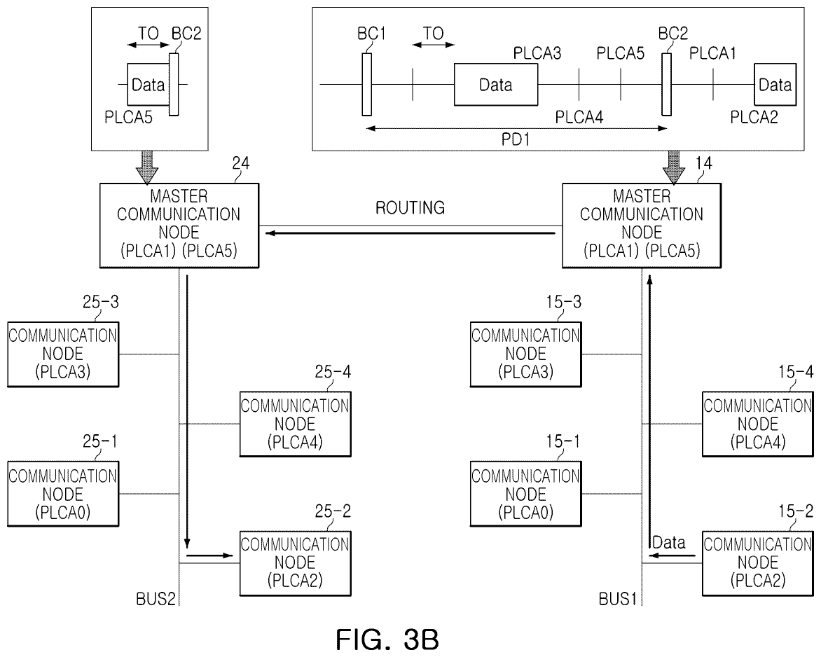

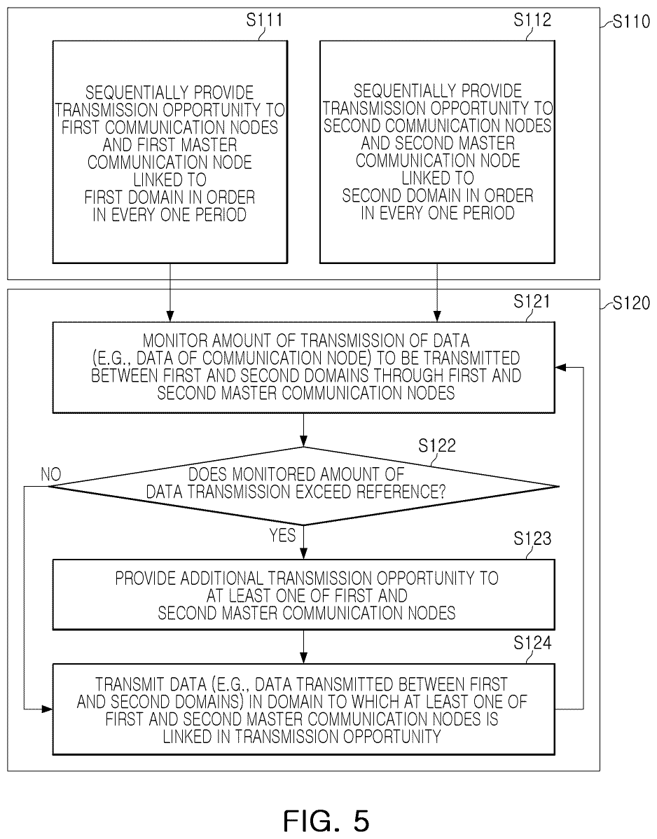

Referring to FIG. 3A, FIG. 3B, and FIG. 5, the transmitting operation (S120) may include, when the amount of the data transmission exceeds the reference (Yes in S122), selectively providing, by at least one of the first and second master communication nodes 14 and 24 an additional transmission opportunity (PLCA5 of FIG. 3B) of the last turn of one period PD1 to at least one of the first and second master communication nodes 14 and 24 according to the result of monitoring the amount of the data transmission (S123).

Accordingly, the first and second master communication nodes 14 and 24 may omit retransmitting the turn setting message to the plurality of communication nodes 15-1 to 15-n and 25-1 to 25-n, while further providing their own transmission opportunity (PLCA5 of FIG. 3B). Thus, the overall transmission schedule stability of the first and second domains BUS1 and BUS2 may be improved.

According to the design, the initial transmission opportunity TO of the first and second master communication nodes 14 and 24 may be set to a later time (e.g., PLCA1) than the duration from the time when the beacon signals BC1 and BC2 are transmitted to the start time of the first transmission opportunity PLCA1 or may be set to a later time (e.g., PLCA1) than the transmission opportunity PLCA0 of some communication nodes 15-1 and 25-1. Here, the transmission opportunity (PLCA5 in FIG. 3B) of the last turn given to the first and second master communication nodes 14 and 24 may be effective because it is given together with the initial transmission opportunity TO of the later time (e.g., PLCA1).

Referring to FIGS. 2A, 2B, and 6, the transmitting operation (S220) may include monitoring and determining, by at least one of the first and second master communication nodes 14 and 24, whether the amount of a data transmission of at least one (e.g., the first communication node 15-2) of the plurality of communication nodes exceeds a reference (S223). This may be performed by checking the amount of a data transmission (e.g., the amount of packets of the data or length/number/bits of data, etc. of frames of the data) of a data transmission request received (S221) from at least one (e.g., the first communication node 15-2) of the plurality of communication nodes 15-1 to 15-n and 25-1 to 25-n. Accordingly, the first and second master communication nodes 14 and 24 may dynamically monitor the amount of a data transmission.

According to the design, at least one of the first and second master communication nodes 14 and 24 may also monitor the total amount of a data transmission of the plurality of communication nodes 15-1 to 15-n and 25-1 to 25-n. Because each of the first and second domains BUS1 and BUS2 may be shared among all of the linked communication nodes, it may also be possible to monitor the amount of a data transmission not transmitted between the first and second master communication nodes 14 and 24 but transmitted only within the first and second domains BUS1 and BUS2. For example, the total amount of a data transmission may include the amount of a data transmission not transmitted between the first and second master communication nodes 14 and 24 but transmitted only within the first and second domains BUS1 and BUS2. For example, a message including data according to Ethernet may include identification data of a communication node that has transmitted the message. The first and second master communication nodes 14 and 24 may monitor the total amount of a data transmission of each of the plurality of communication nodes 15-1 to 15-n and 25-1 to 25-n by checking the identification data.

According to the design, at least one of the first and second master communication nodes 14 and 24 may monitor the amount of a data transmission in a previous period (e.g., duration from BC1 to BC2) of at least one of the plurality of communication nodes 15-1 to 15-n and 25-1 to 25-n. The at least one of the first and second master communication nodes 14 and 24 may selectively provide an additional transmission opportunity in a subsequent period (e.g., time after BC2) than in the previous period (e.g., duration from BC1 to BC2) to at least one of the first and second master communication nodes 14 and 24 according to the result of monitoring the amount of a data transmission. In other words, the first and second master communication nodes 14 and 24 may be adaptively provided with transmission opportunities according to changes in the overall amount of a data transmission of the plurality of communication nodes 15-1 to 15-n and 25-1 to 25-n. Thus, the communication delay time may be effectively prevented from becoming longer due to a significant change in the amount of a data transmission.

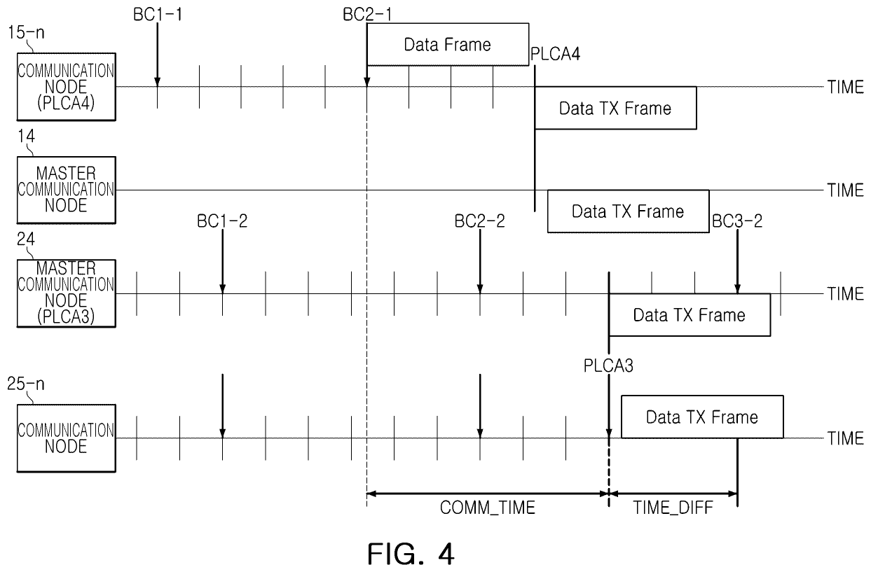

FIG. 4 assumes that beacon signals BC1-1 and BC2-1 of the first domain and beacon signals BC1-2, BC2-2, and BC3-2 of the second domain are not synchronized with each other. Referring to FIG. 4, even if the first communication node 15-n generates data (Data Frame) to be transmitted from the time of receiving the beacon signal BC2-1, it may transmit data (Data TX Frame) after waiting for until the transmission opportunity PLCA4 of the first communication node 15-n.

The first master communication node 14 may immediately transmit the data (Data TX Frame) received from the first communication node 15-n to the second master communication node 24. The time at which the second master communication node 24 receives the data (Data TX Frame) may be a time after the start of the first transmission opportunity, beyond the time at which the beacon signal (BC2-2) was transmitted. At this time, the second master communication node 24 may be additionally provided with the transmission opportunity PLCA3, so that the second master communication node 24 may transmit the data (Data TX Frame) to the second communication node (25-n) at the transmission opportunity PLCA3.

The communication required time COMM_TIME may be defined as a duration from the time when the first communication node 15-n generates the data (Data Frame) to be transmitted to the time when the second master communication node 24 transmits the data (Data TX Frame). If the second master communication node 24 is not provided with the additional transmission opportunity PLCA3, the second master communication node 24 may transmit data at the initial transmission opportunity corresponding to the time at which the beacon signal BC3-2 was transmitted, which may further cause a communication delay time TIME_DIFF. However, the method and apparatus for controlling communication of data collision avoidance in a domain according to an embodiment of the present disclosure may prevent the occurrence of the communication delay time TIME_DIFF and may reduce the communication required time COMM_TIME.

Meanwhile, referring to FIG. 1, the vehicle 11 according to an embodiment of the present disclosure may include a computer device 500 including a processor 501 and a storage medium 502 storing one or more programs 502a configured to be executable by the processor 501. The one or more programs 502a may include commands for executing the method for controlling communication of data collision avoidance in a domain according to an embodiment of the present disclosure.

The computer device 500 may include at least one processor 501, the computer-readable storage medium 502, and a communication bus 503. The communication bus 503 may interconnect various other components of the computer device 500, including the processor 501 and the computer-readable storage medium 502. For example, the computer device 500 may be implemented as a microcontroller.

The processor 501 may cause the computer device 500 to operate according to the embodiments mentioned above. For example, the processor 501 may execute one or more programs stored in the computer-readable storage medium 502. The one or more programs may include one or more computer-executable instructions, and the computer-executable instructions may be configured to cause, when executed by the processor 501, the computer device 500 to perform operations according to the embodiments.

The computer-readable storage medium 502 may be configured to store computer-executable instructions or program code, program data, and/or other suitable forms of information. A program 502a stored on the computer-readable storage medium 502 includes a set of instructions executable by the processor 501. In an embodiment, the computer-readable storage medium 502 may be a memory (volatile memory, such as random access memory, nonvolatile memory, or a suitable combination thereof), one or more magnetic disk storage devices, optical disk storage devices, flash memory devices, or any other form of storage medium that may be accessed by the computer device 500 and capable of storing desired information, or a suitable combination thereof.

The computer device 500 may also include one or more input/output interfaces 506 providing an interface for one or more input/output devices 505 and may include one or more network communication interfaces 504. The input/output interfaces 506 and the network communication interfaces 504 are connected to the communication bus 503. The network may be one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller region Network (CAN), Local Interconnect Network (LIN), Internet, Bluetooth, Near Field Communication (NFC), Zigbee, Radio Frequency (RF), etc.

The input/output device 505 may be connected to other components of the computer device 500 via the input/output interface 506. The input/output devices 505 may include, for example, input devices, such as pointing devices (such as a mouse or trackpad), keyboards, touch input devices (such as a touchpad or a touchscreen), voice or sound input devices, various types of sensor devices and/or image capturing devices, and/or output devices, such as display devices, printers, speakers, and/or network cards. For example, the input/output devices 505 may be inside the computer device 500 as a component constituting the computer device 500 or may be connected to the computer device 500 as a separate device distinct from the computer device 500.

Meanwhile, the embodiments of the present disclosure may include a program for performing the methods described in the present disclosure on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

The method and apparatus for controlling communication of data collision avoidance in a domain according to an embodiment of the present disclosure and the vehicle and the storage medium including the same may reduce communication delay time (e.g., TIME_DIFF in FIG. 4) while preventing data collisions in a domain.

Only some embodiments are described. Variations, improvements, and enhancements of the disclosed embodiments and other embodiments may fall within the scope of the present disclosure.

What is claimed is:

1. A method for controlling communication of data collision avoidance in a domain, the method comprising:
sequentially providing, by a first master communication node or a second master communication node respectively linked to a first domain and a second domain, transmission opportunities to a plurality of communication nodes linked to the first domain or the second domain during each period; and
transmitting, by the first master communication node or the second master communication node, data received from at least one of the plurality of communication nodes between the first domain and the second domain within the first domain or the second domain in a transmission opportunity;
monitoring an amount of a data transmission of the at least one of the plurality of communication nodes; and
selectively providing an additional transmission opportunity to at least one of the first master communication node or the second master communication node according to a result of monitoring the amount of the data transmission.

2. The method of claim 1, wherein transmitting, by the first master communication node or the second master communication node, the data between the first domain and the second domain is not limited to the transmission opportunities of the first master communication node and the second master communication node.

3. The method of claim 2, wherein the plurality of communication nodes are restricted from transmitting data out of the linked first domain or the linked second domain by bypassing the first master communication node and the second master communication node.

4. The method of claim 1, further comprising:
receiving a message including the data according to Ethernet from at least one of the plurality of communication nodes;
transmitting the message including the data according to Ethernet between the first domain and the second domain; and
transmitting the message including the data according to Ethernet within the first domain or the second domain in the transmission opportunity.

5. The method of claim 4, further comprising:
transmitting, by the first master communication node or the second master communication node, a beacon signal to the plurality of communication nodes during each period.

6. The method of claim 1, further comprising:
selectively transmitting a turn setting message for delaying a transmission opportunity turn of at least some of the plurality of communication nodes to at least some of the plurality of communication nodes; and
selectively providing an additional transmission opportunity of a front turn of the delayed transmission opportunity turn of one period to at least one of the first master communication node or the second master communication node according to the result of monitoring the amount of the data transmission.

7. The method of claim 1, further comprising:
selectively providing an additional transmission opportunity of a last turn of one period to at least one of the first master communication node and the second master communication node according to the result of monitoring the amount of the data transmission.

8. The method of claim 1, further comprising:
monitoring, by at least one of the first master communication node or the second master communication node, the amount of the data transmission of at least one of the plurality of communication nodes by checking the amount of the data transmission of a data transmission request received from at least one of the plurality of communication nodes.

9. The method of claim 1, further comprising:
monitoring, by at least one of the first master communication node or the second master communication node, a total amount of the data transmission of the plurality of communication nodes.

10. The method of claim 1, further comprising:
monitoring, by at least one of the first master communication node and the second master communication node, the amount of the data transmission in a previous period of at least one of the plurality of communication nodes; and
selectively providing an additional transmission opportunity in a subsequent period than in the previous period to at least one of the first master communication node and the second master communication node according to the result of the monitoring the amount of the data transmission.

11. A vehicle comprising:
a computer device including:
a non-transitory computer readable storage medium configured to record one or more programs; and
a processor configured, by executing the one or more programs, to perform the method for controlling the communication of the data collision avoidance in the domain according to claim 1.

12. A non-transitory computer readable storage medium configured to record one or more programs including commands for executing the method for controlling the communication of the data collision avoidance in the domain according to claim 1.

13. An apparatus for controlling communication of data collision avoidance in a domain, the apparatus comprising:
a first master communication node configured to sequentially provide transmission opportunities to a plurality of first communication nodes linked to a first domain during each period; and
a second master communication node configured to sequentially provide transmission opportunities to a plurality of second communication nodes linked to a second domain during each period,
wherein the first master communication node is further configured to:
receive data from at least one of the plurality of first communication nodes; and
transmit the data to the second master communication node, and
wherein the second master communication node is further configured to:
transmit the data to at least one of the plurality of second communication nodes in a transmission opportunity, and
wherein at least one of the first master communication node or the second master communication node is further configured to:
monitor an amount of a data transmission of at least one of the plurality of first communication nodes; and
selectively provide an additional transmission opportunity to the other one of the first master communication node or the second master communication node according to a result of monitoring the amount of a data transmission.

14. The apparatus of claim 13,
wherein the first master communication node is further configured to:
receive a message including data according to Ethernet from at least one of the plurality of first communication nodes; and
transmit the message to the second master communication node, and
wherein the second master communication node is further configured to:
transmit the message including the data according to Ethernet to at least one of the plurality of second communication nodes.

15. The apparatus of claim 14, wherein the first master communication node and the second master communication node are further configured to:
transmit the data between the first domain and the second domain without being limited to the transmission opportunities of the first master communication node and the second master communication node,
wherein the plurality of first communication nodes is restricted from transmitting data to the plurality of second communication nodes by bypassing the first master communication node and the second master communication node, and
wherein the plurality of second communication nodes is restricted from transmitting data to the plurality of first communication nodes by bypassing the first master communication node and the second master communication node.

16. The apparatus of claim 14,
wherein the first master communication node is further configured to:
transmit a beacon signal to the plurality of first communication nodes during each period,
wherein the second master communication node is further configured to:
transmit a beacon signal to the plurality of second communication nodes during each period, and
wherein at least one of the first master communication node or the second master communication node is further configured to:
selectively transmit a turn setting message for delaying a transmission opportunity turn of at least some of the plurality of second communication nodes to at least some of the plurality of second communication nodes; and
selectively provide an additional transmission opportunity of a front turn of the delayed transmission opportunity turn of one period to the other one of the first master communication node and the second master communication node according to the result of monitoring the amount of the data transmission.

17. The apparatus of claim 14,
wherein the first master communication node is further configured to:
transmit a beacon signal to the plurality of first communication nodes during each period,
wherein the second master communication node is further configured to:
transmit a beacon signal to the plurality of second communication nodes during each period, and
wherein at least one of the first master communication node or the second master communication node is further configured to:
selectively provide an additional transmission opportunity of a last turn of the one period to the other one of the first master communication node and the second master communication node according to the result of monitoring the amount of the data transmission.

18. The apparatus of claim 14, wherein at least one of the first master communication node or the second master communication node is further configured to:
monitor the amount of the data transmission of at least one of the plurality of first communication nodes by checking the amount of the data transmission of a data transmission request received from at least one of the plurality of first communication nodes.

19. A vehicle including the apparatus for controlling the communication of the data collision avoidance in the domain according to claim 13.
